(19) United States
(12) Patent Application Publication
(10) Pub. No.: US 2005/0076572 A1
(43) Pub. Date: Apr. 14, 2005

(54) Window glass and method for adjusting a window glass in a vehicle door

(76) Inventors: Patrice Cardine, Flaubert (FR); Denis Chevy, Neuvy En Sullias (FR)

Correspondence Address: CARLSON, GASKEY & OLDS, P.C., 400 WEST MAPLE ROAD, SUITE 350, BIRMINGHAM, MI, 48009, US

(21) Appl. No.: 10/963,431

(22) Filed: Oct. 12, 2004

(30) Foreign Application Priority Data
Oct. 10, 2003 (FR) 03 11 880

(51) Int. Cl. E05F 11/38

(52) U.S. Cl. 49/348

(57) ABSTRACT

A vehicle window glass includes a side edge, a top edge which is oblique with respect to the side edge, and an adjustment feature for the window glass which extends in a direction substantially parallel to the top edge of the window glass. The adjustment feature can be an oblong hole in the window glass or a slideway bonded to the window glass. The window glass can be finely adjusted in the longitudinal direction of the vehicle, ensuring the top edge always follows the same oblique line. This reduces the number of steps involved in adjusting the window glass once installed in the vehicle.

### REFERENCE TO RELATED APPLICATIONS

This application claims priority to French Patent Application FR 03 11 880 filed on Oct. 10, 2003.

### BACKGROUND OF THE INVENTION

The present invention relates to a window glass and a method for adjusting the window glass in a vehicle door.

In a vehicle door, and in particular a frameless door, a top edge of a window glass may be inclined with respect to a bottom edge. However, it is difficult to correctly adjust the window glass with respect to the remainder of the vehicle. The window glass can be shifted in the longitudinal direction of the vehicle, that is, forwardly and backwardly. However, because the top edge is sloped, moving the window glass longitudinally can misalign the window glass in the vertical direction of the vehicle. The window glass then needs to be adjusted during vehicle mass production.

There is consequently a need for a vehicle window glass and a method of adjusting a window glass that reduces the steps necessary for adjusting the window glass in the vehicle.

### SUMMARY OF THE INVENTION

According to the invention, a vehicle window glass includes a side edge, a top edge that is oblique with respect to the side edge, a lower edge opposite to the top edge and an adjustment feature for the window glass that extends in a direction substantially parallel to the top edge of the window glass. The adjustment feature is preferably located near the lower edge of the window glass. A securing feature is preferably provided at the same edge as the adjustment feature. The top edge is preferably oblique with respect to the bottom edge.

The adjustment feature can be an oblong hole, preferably circumscribed by the window glass, or a slideway preferably bonded to the window glass. The adjustment feature preferably adjusts the window glass within 3.5 mm with respect to a nominal position.

A vehicle door includes a window regulator and a window glass that is moveable by the window regulator. A method of adjusting the window glass in the vehicle door includes the step of adjusting the window glass in a direction substantially parallel to a top edge of the window glass.

When the window regulator includes a first slider, the window glass is connected to the first slider by the adjustment feature, and the window glass can be adjusted by relative displacement between the first slider and the adjustment feature.

Preferably, the window regulator further includes a second slider, and the window glass is connected to the second slider by a securing feature. The step of adjusting the window glass, prior to the relative displacement between the first slider and the adjustment feature, preferably includes first positioning the securing feature with respect to the second slider. Once the window glass has been positioned, the window glass is secured to the second slider of the window regulator by the securing feature. Once the window glass is in position, the window glass is preferably secured to the first slider of the window regulator by the adjustment feature.

Further characteristics and advantages of the invention will become more clear from the detailed description which follows of some embodiments, provided solely by way of example and with reference to the attached drawings:

### BRIEF DESCRIPTION OF THE DRAWINGS

FIG. 1 shows a window glass according to one embodiment; and

FIG. 2 shows a vehicle door incorporating the window glass of FIG. 1.

### DETAILED DESCRIPTION OF PREFERRED EMBODIMENTS

A vehicle window glass includes a side edge and an upper edge that is sloped with respect to the side edge. The window glass also includes an adjustment feature that extends in a direction substantially parallel to the top edge. The window glass can thus be shifted in a direction parallel to the top edge of the window glass to adjust the position of the window glass. This makes it possible to adjust the position of the window glass along the longitudinal axis of the vehicle while at the same time keeping the top edge present along the same line, reducing the number of steps for adjusting the window glass in the vehicle.

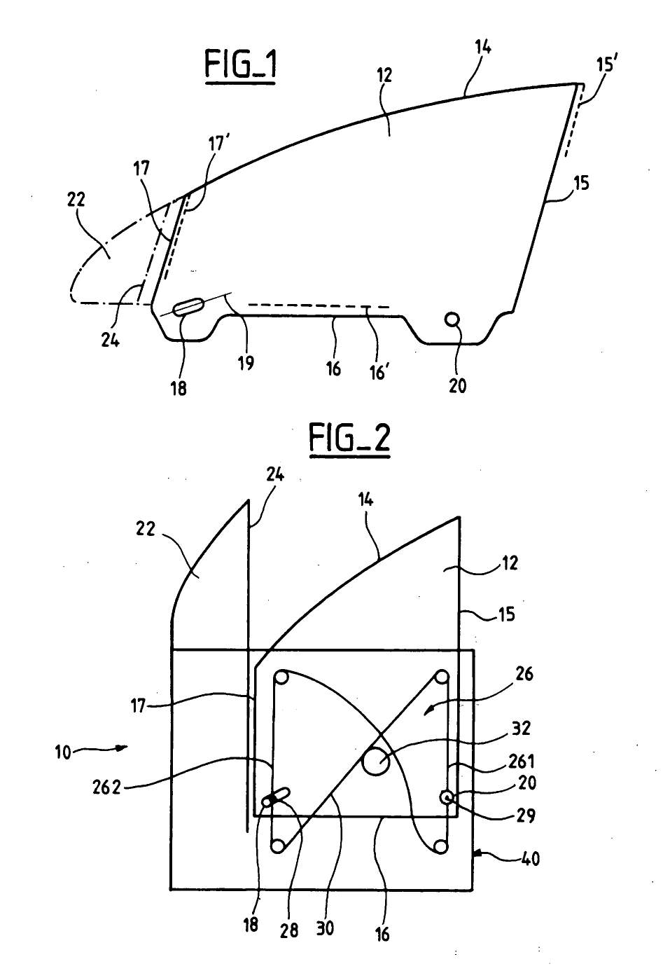

FIG. 1 shows a window glass 12 according to one embodiment. The window glass 12 includes a side edge 17 and a top edge 14 that is sloped with respect to the side edge 17. In a vehicle, the top edge 14 ensures continuity along a line running between a windscreen area and the vehicle roof. The window glass 12 also includes an adjustment feature 18 for adjusting the window glass 12 once it is initially positioned in the door. The adjustment feature 18 extends in a direction indicated by a somewhat longitudinal axis 19 that is substantially parallel to the top edge 14.

Thus, the position of the window glass 12 can be adjusted, for example, to move the window glass closer to a rear window glass. The window glass 12 can be shifted towards the right in FIG. 1 until the side edge 17 adopts a position 17′, shown in dashed lines. The window glass 12 is shifted in the direction of the top edge 14 using the adjustment feature 18. During adjustment, the top edge 14 is shifted along the line that joins the windscreen and the rear side window. The window glass 12 is thus shifted longitudinally without the top edge 14 losing its vertical position in the vehicle door 10. Adjustment of the position of the window glass 12 is performed simultaneously along the longitudinal and vertical directions of the vehicle. It is not necessary to provide a supplemental and separate step for vertical adjustment of the window glass 12. This makes the adjustment of the window glass 12 faster and more suitable for mass production speeds.

In FIG. 1, the side edge 17 is, for example, the front edge of the window glass 12 taken in the longitudinal direction of the vehicle. The side edge 17 is, for example, close to the vehicle windscreen and can be substantially vertical with respect to the vehicle.

The top edge 14 may cut or intersect the side edge 17 and extend towards the rear of the vehicle from the side edge 17. The top edge 14 can be continuous without irregularities. This provides for better compression of a roof seal when the window glass 12 is in a raised position, ensuring better sealing of the passenger compartment.

The top edge 14 is sloped with respect to the side edge 17 such that the top edge 14 and the side edge 17 form an angle. That is, the top edge 14 is inclined with respect to the side edge 17 without being perpendicular to the side edge 17. The top edge 14 may also have a first section that is at an oblique angle with respect to the side edge 17 and a second section that is more horizontal than the first section. This second section may be substantially perpendicular to the side edge 17.

The top of the vehicle windscreen can, for example, be lower than the top of a rear window glass when the rear window glass is at the raised position. In this case, the top edge 14 will extend higher up in the vehicle when moving away from the front of the vehicle.

The adjustment feature 18 make it possible to adjust the position of the window glass 12 due to the elongated shape that extends in a direction substantially parallel to the top edge 14. The top edge 14 may nevertheless be bowed, and the adjustment feature 18 is then locally parallel to the top edge 14. More exactly, the adjustment feature 18 is parallel to a tangent of the top edge 14, and the tangent is locally incorporated into the top edge 14.

The adjustment feature 18 can be an oblong opening. The oblong opening has the longitudinal axis 19 extending in a direction substantially parallel to the top edge 14. A window glass slider is placed into the oblong opening, as will be explained below.

Alternatively, the adjustment feature 18 can be a slideway in which a window regulator slider moves. The slideway can be bonded or screwed to the window glass 12, ensuring that the slideway is rapidly secured to the window glass 12. The slideway can also be fastened through a hole in the window glass 12, allowing more secure fastening of the slideway. The advantage of this slideway is that it can be readily oriented while it is being fastened. Regardless of its specific form, the adjustment feature 18 is easy to provide and provides a savings on production costs and quick adjustment.

The holes made in the window glass 12 to provide the adjustment feature 18 can be circumscribed by the window glass 12, providing a more secure connection with the window glass 12.

The window glass 12 includes two other edges 15 and 16. The side edge 15 is parallel to and opposite to the side edge 17. In FIG. 1, the side edge 15 is the edge of the window glass 12 that is directed towards the rear of the vehicle. The lower edge 16 is opposite to the top edge 14. The lower edge 16 is not designed to be visible. The top edge 14 can also be inclined with respect to the lower edge 16. An acute angle can be formed between the top edge 14 and the lower edge 16. The window glass 12 has a substantially trapezoidal shape, providing a savings on the material of the window glass 12. The top edge 14 and the lower edge 16 can also be substantially parallel, simplifying construction of the window glass 12.

When the window glass 12 is being adjusted, the side edge 17 can adopt the position 17′, and the side edge 15 can adopt the position 15′. The side edge 15 is thus, for example, in closer contact with the rear window glass. During adjustment, the window glass 12 is raised towards the rear of the vehicle along the direction of the top edge 14, and the lower edge 16 raises to a higher position 16′. The new position of the lower edge 16 is not important, provided that the lower edge 16 remains inside the door and connected to the window regulator mechanism. What is important is that the top edge 14 stays in the same line to ensure faster adjustment of the window glass 12 into position.

FIG. 2 shows a vehicle door 10 that includes the window glass 12 of FIG. 1. The window glass 12 is operated by a window regulator 26 that includes one or several guide rails. In FIG. 2, two guide rails 261 and 262 are shown, but it is possible for only one single rail to be employed. The window regulator 26 also includes one or more sliders 28 and 29, equal to the number of rails employed. The sliders 28 and 29 are respectively guided along the guide rails 262 and 261 and are driven linearly by a cable 30 and a drum 32. As the sliders 28 and 29 move along the guide rails 262 and 261, the sliders 28 and 29 move the window glass 12 linearly with respect to the vehicle door 10.

The window glass 12 is operated by the window regulator 26, and the window glass 12 can be connected to the slider 28 by the adjustment feature 18. The window glass 12 can be secured to the window regulator 26 once the appropriate position has been set. The vehicle door 10 can include an opening to allow access to the window glass 12 to secure it.

The window regulator 26 allows the window glass 12 to be moved from a lower position in a door shell 40, in which the lower edge 16 is at least partially inside the door shell 40, up to a raised position in which the top edge 14 is completely extended. The lower edge 16 preferably remains inside the door shell 40, regardless of the position of the window glass 12. In particular, in the raised position, the lower edge 16 remains inside the door shell 40, maintaining contact between the window glass 12 and a lip seal on the door shell 40 for sealing purposes.

The vehicle door 10 can be a frameless door. In this example, the window glass 12 is guided linearly by a single slideway 24. The side edge 17 of the window glass 12 is guided linearly by the slideway 24, which extends from inside the door shell 40 and projects from the door shell 40. The slideway 24 guides the side edge 17 both inside and outside the door shell 40.

The vehicle door 10 can include a forward panel 22 which, for example, occupies the corner between the windscreen, the window glass 12 and the door shell 40. The forward panel 22 can be used to secure a rear view mirror or can be a window glass that increases visibility for occupants inside the vehicle. The forward panel 22 is preferably non-moveable, simplifying construction. The forward panel 22 can have a top edge, the line of which extends along the top edge 14 of the window glass 12.

The adjustment feature 18 can be located at the lower edge 16, which is opposite the top edge 14. This allows the position of the window glass 12 to be adjusted so that the part of the window glass 12 that projects out of the door shell 40 can be suitably positioned with respect to the remainder of the vehicle, and the part of the window glass 12 that remains inside the door shell 40 adapts itself as a result. The part of the window glass 12 that is located inside the door shell 40 can occupy any space, as long as sealing of the window glass 12 is ensured when the window glass 12 is raised. The portion of the window glass 12 that stays inside the door shell 40 and located below the adjustment feature 18 can be omitted, providing a savings on material and cost.

The adjustment feature 18 adjusts a position of the window glass within 3.5 mm with respect to a nominal position at which the slider 28 is substantially at the center of the adjustment feature 18. The slope of the longitudinal axis 19 of the adjustment feature 18 can be approximately 45 degrees.

The adjustment feature 18 can also secure the window glass 12 to the window regulator 26. Once the window glass 12 is positioned with respect to the remainder of the vehicle, the window glass 12 is secured by bonding or screwing. Thus, the same feature is used to both adjust and secure the window glass 12. The window glass 12 can also include a secondary securing feature 20 for the window glass 12, ensuring greater stability of the window glass 12. The secondary securing feature 20 is, for example, a hole in the window glass and can also have an elongated shape to allow for adjustment of the window glass 12. The secondary securing feature 20 is preferably also located at the lower edge 16 that is opposite to the top edge 14. The adjustment feature 18 and the secondary securing feature 20 are located at the lowest portion of the window glass 12 to provide a savings on material and costs. The adjustment feature 18 and the secondary securing feature 20 can be locally circumscribed by the window glass 12 by providing projecting bosses at the lower edge 16 that are directed towards the bottom of the window glass 12. The bosses locally reinforce the window glass 12, which might be rendered weaker by the adjustment feature 18 and the secondary securing feature 20.

The slider 28 or the sliders 28 and 29 cooperate with the adjustment feature 18 and the secondary securing feature 20. The sliders 28 and 29 have, for example, a lug that cooperates with the adjustment feature 18 and the secondary securing feature 20. The lugs can, for example, be inserted into the adjustment feature 18 and the secondary securing feature 20. The adjusting feature 18 and the secondary securing feature 20 are then bonded or screwed onto the sliders 28 and 29. It is also possible to employ just one single slider 28 that cooperates with the adjustment feature 18.

The present invention also provides a method for adjusting a window glass 12 in a door, for example a frameless door. A problem associated with frameless doors is that the window glass 12 is responsible for providing a line of continuity, notably with a rear window glass, of the vehicle. This continuous line provides better sealing with the vehicle roof or better aerodynamics if the roof is opened. The method allows the window glass 12 to be adjusted towards the front or rear of the vehicle while the vehicle is being assembled, making it possible to obtain the continuous line.

The vehicle door 10 includes the window glass 12 and the window regulator 26. The window glass 12 is connected to the slider 28 of the window regulator 26 by the adjustment feature 18. The window glass 12 is mounted to the window regulator 26 and retained without falling while being moveable by the window regulator 26.

The method further includes the step of adjusting the window glass 12 in a direction substantially parallel to the top edge 14 of the window glass 12. The window glass 12 is preferably in the raised position and able to adjust its position to the remainder of the vehicle. In particular, when the vehicle door 10 is mounted on the remainder of the vehicle, the window glass 12 is adjusted to be in contact, notably with the rear window glass. As the top edge 14 is inclined with respect to the side edge 17, shifting and adjusting the window glass 12 with respect to the remainder of the vehicle can lead to a discontinuity, for example, with the top edge of the forward panel 22. To avoid such discontinuity, the method ensures that the top edge 14 remains along the same line during the adjustment of the window glass 12. This makes it possible to adjust the longitudinal position of the window glass 12 without having to adjust the vertical position in the vehicle door 10. Thus, any adjustment in the longitudinal direction of the window glass 12 does not change the vertical position of the top edge 14, which consequently becomes independent of the adjustment of the window glass 12 in a longitudinal direction of the vehicle.

The step of adjusting the window glass 12 is performed by relative displacement between the slider 28 and the adjustment feature 18. The window glass 12 is shifted by sliding the adjustment feature 18 with respect to the slider 28. The slider 28 is preferably locked to prevent it from moving along the guide rail 261. The slider 28 moves towards the bottom of the window glass 12 as a function of the orientation shown in FIG. 2 and with respect to the adjustment feature 18. When a second slider 29 is present, the second slider 29 is also preferably locked to prevent it moving along the guide rail 261.

The window regulator 26 can include the second slider 29, and the window glass 12 is joined to the second slider 29 by the secondary securing feature 20. Prior to the relative displacement between the first slider 28 and the adjustment feature 18, adjustment of the window glass 12 first includes positioning of the secondary securing feature 20 with respect to the second slider 29. If the position of the window glass 12 varies along the longitudinal axis of the vehicle, the adjustment feature 18 nevertheless allows the top edge 14 to be kept along a given line.

The method finally includes the step of securing the window glass to the window regulator 26 once the window glass 12 has been positioned. If the window glass 12 includes the secondary securing feature 20, the window glass 12 can first be secured with respect to the secondary securing feature 20 after which the adjustment feature 18 allows the consequent adaptation of the window glass 12. Once in position, the window glass 12 is secured to the slider 28 of the window regulator 26 via the adjustment feature 18.

Obviously, the invention is not limited to the embodiments described by way of example. Thus, the assembly including the window glass 12 with the adjustment feature 18 is not limited to a frameless door. The window glass 12 can also be mounted in a vehicle door 10 with a frameto be able to adjust a position of the window glass 12 with respect to the window glass slideways.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

1. A vehicle window glass comprising:
a side edge;
a top edge that is oblique with respect to the side edge; and
an adjustment feature for the vehicle window glass that extends in a direction substantially parallel to the top edge of the vehicle window glass.

2. The window glass according to claim 1, wherein the vehicle window glass includes a lower edge that is opposite to the top edge, and the adjustment feature is located near the lower edge of the vehicle window glass.

3. The window glass according to claim 2, wherein the top edge is oblique with respect to the lower edge.

4. The window glass according to claim 1, wherein the adjustment feature is an oblong hole.

5. The window glass according to claim 1, wherein the adjustment feature is circumscribed by the vehicle window glass.

6. The window glass according to claim 1, wherein the adjustment feature is a slideway.

7. The window glass according to claim 6, wherein the slideway is bonded to the vehicle window glass.

8. The window glass according to claim 2, further including a securing feature located at the lower edge.

9. The window glass according to claim 8, wherein the top edge is oblique with respect to the lower edge.

10. The window glass according to claim 9, wherein the adjustment feature is an oblong hole.

11. The window glass according to claim 10, wherein the adjustment mechanism is circumscribed by the window glass.

12. The window glass according to claim 9, wherein the adjustment feature is a slideway.

13. The window glass according to claim 12, wherein the slideway is bonded to the vehicle window glass.

14. The window glass according to claim 1, wherein a degree of adjustment of the vehicle window glass provided by the adjustment feature is within 3.5 mm of a nominal position.

15. A vehicle door comprising:
a window regulator; and
a vehicle window glass including:
a side edge,
a top edge that is oblique with respect to said the side edge, and
an adjustment feature for the vehicle window glass extending in a direction substantially parallel to the top edge of the vehicle window glass, wherein the vehicle window glass is moveable by the window regulator.

16. A method of adjusting a vehicle window glass in a vehicle including a window regulator, a vehicle window glass having a side edge and a top edge that is oblique with respect to the side edge and an adjustment feature for the vehicle window glass extending in a direction substantially parallel to the top edge of the vehicle window glass, and the vehicle window glass being moveable by the window regulator, the method comprising the steps of:
positioning the vehicle window glass in the vehicle door; and
adjusting the vehicle window glass in the direction substantially parallel to the top edge of the vehicle window glass.

17. The method according to claim 16, wherein the window regulator includes a first slider, and the vehicle window glass is connected to the first slider by the adjustment feature, and wherein the step of adjusting is performed by relative displacement between the first slider and the adjustment feature.

18. The method according to claim 17, wherein the window regulator further includes a second slider, and the vehicle window glass is connected to the second slider by a securing feature, and wherein the step of adjusting the window glass includes positioning the securing feature with respect to the second slider before the relative displacement between the first slider and the adjustment feature.

19. The method according to claim 18, further including the step of securing the vehicle window glass to the second slider of the window regulator by the securing feature after the step of positioning the vehicle window glass.

20. The method according to claim 17, further including the step of securing the vehicle window glass to the first slider of the window regulator by the adjustment feature after the step of positioning the vehicle window glass.
